(19) United States
(12) Patent Application Publication
(10) Pub. No.: US 2018/0006977 A1
(43) Pub. Date: Jan. 4, 2018

(54) EXPOSING TASK INFORMATION TO ONLINE SERVICE PROVIDERS

(71) Applicant: Microsoft Technology Licensing, LLC, Redmond, WA (US)

(72) Inventors: Ajoy Nandi, Redmond, WA (US); Jason T. Creighton, Bellevue, WA (US); Nikrouz Ghotbi, Redmond, WA (US); Ryen W. White, Woodinville, WA (US); Jonathan E. Hamaker, Issaquah, WA (US); Zain Aziz, Snoqualmie, WA (US)

(21) Appl. No.: 15/199,233

(22) Filed: Jun. 30, 2016

(51) Int. Cl. H04L 12/58; H04L 29/08; G10L 15/26

(52) U.S. Cl. CPC H04L 51/046; H04L 67/20; H04L 67/18; H04L 51/26; H04L 51/22; G10L 15/26

(57) ABSTRACT

Task information is exposed to providers of online services. A dataset that includes one or more electronic messages is received. Then, one or more task intents in the dataset are identified, where each of the identified task intents is a specific task that is to be completed. Then, for each of the identified task intents, one or more service providers each of whom offers one or more online services that are capable of assisting in the fulfillment of the identified task intent are identified, and information associated with the identified task intent is exposed to each of the identified service providers.

### BACKGROUND

The Internet is a global data communications system that serves billions of people across the globe and provides them access to a vast array of online information resources and online services including those provided by the World Wide Web and intranet-based enterprises. Thanks to the ubiquity of the Internet and the wide variety of network-enabled end-user computing devices that exist today, people today spend a large and ever-increasing amount of time online. People today also heavily rely on electronic messages to communicate with each other in both a professional and a personal context. In other words, people today frequently have conversations by sending electronic messages to each other over a data communication network. People today also routinely use a variety of the online services that are available on the Internet.

### SUMMARY

Task information exposition technique implementations described herein generally involve exposing task information to providers of online services. In one exemplary implementation a dataset that includes one or more electronic messages is received. Then, one or more task intents in the dataset are identified, where each of the identified task intents is a specific task that is to be completed. Then, for each of the identified task intents, one or more service providers each of whom offers one or more online services that are capable of assisting in the fulfillment of the identified task intent are identified, and information associated with the identified task intent is exposed to each of the identified service providers.

It should be noted that the foregoing Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter. Its sole purpose is to present some concepts of the claimed subject matter in a simplified form as a prelude to the more-detailed description that is presented below.

### DESCRIPTION OF THE DRAWINGS

The specific features, aspects, and advantages of the task information exposition technique implementations described herein will become better understood with regard to the following description, appended claims, and accompanying drawings where:

FIG. 1 is a diagram illustrating an exemplary implementation, in simplified form, of a system framework for realizing the task information exposition technique implementations described herein.

FIG. 2 is a flow diagram illustrating one implementation, in simplified form, of a process for exposing task information.

FIG. 3 is a flow diagram illustrating one implementation, in simplified form, of a process for exposing information associated with an identified task intent to service providers who are identified as offering online services that are capable of assisting in the fulfillment of the identified task intent.

FIG. 4 is a flow diagram illustrating another implementation, in simplified form, of a process for exposing information associated with the identified task intent to the identified service providers.

FIG. 5 is a flow diagram illustrating yet another implementation, in simplified form, of a process for exposing information associated with the identified task intent to the identified service providers.

FIG. 6 is a flow diagram illustrating another implementation, in simplified form, of a process for exposing task information.

FIG. 7 is a flow diagram illustrating one implementation, in simplified form, of a process for sending a list of service providers who are identified as offering online services that are capable of assisting in the fulfillment of an identified task intent to a person who is identified as being assigned to fulfill the identified task intent whenever the identified service providers include a plurality of service providers.

FIG. 8 is a flow diagram illustrating another implementation, in simplified form, of a process for sending a list of the identified service providers to the identified person whenever the identified service providers include a plurality of service providers.

FIG. 9 is a flow diagram illustrating an exemplary implementation, in simplified form, of a process for exposing information associated with the identified task intent to a selected one of the identified service providers in the case where the selected one of the identified service providers requested that one or more specific types of information be provided to this selected provider in order for this selected provider to be able to assist in the fulfillment of the identified task intent.

FIG. 10 is a textual record illustrating an exemplary implementation, in simplified form, of an email thread that is communicated between a plurality of people.

FIG. 11 is a diagram illustrating one implementation, in simplified form, of a task information exposer computer program for exposing task information.

FIG. 12 is a diagram illustrating another implementation, in simplified form, of a task information exposer computer program for exposing task information.

FIG. 13 is a diagram illustrating a simplified example of a general-purpose computer system on which various implementations and elements of the task information exposition technique, as described herein, may be realized.

### DETAILED DESCRIPTION

In the following description of task information exposition technique implementations reference is made to the accompanying drawings which form a part hereof, and in which are shown, by way of illustration, specific implementations in which the task information exposition technique can be practiced. It is understood that other implementations can be utilized and structural changes can be made without departing from the scope of the task information exposition technique implementations.

It is also noted that for the sake of clarity specific terminology will be resorted to in describing the task information exposition technique implementations described herein and it is not intended for these implementations to be limited to the specific terms so chosen. Furthermore, it is to be understood that each specific term includes all its technical equivalents that operate in a broadly similar manner to achieve a similar purpose. Reference herein to “one implementation”, or “another implementation”, or an “exemplary implementation”, or an “alternate implementation”, or “one version”, or “another version”, or an “exemplary version”, or an “alternate version”, or “one variant”, or “another variant”, or an “exemplary variant”, or an “alternate variant” means that a particular feature, a particular structure, or particular characteristics described in connection with the implementation or version can be included in at least one implementation of the task information exposition technique. The appearances of the phrases “in one implementation”, “in another implementation”, “in an exemplary implementation”, “in an alternate implementation”, “in one version”, “in another version”, “in an exemplary version”, “in an alternate version”, “in one variant”, “in another variant”, “in an exemplary variant”, and “in an alternate variant” in various places in the specification are not necessarily all referring to the same implementation or version, nor are separate or alternative implementations/versions mutually exclusive of other implementations/versions. Yet furthermore, the order of process flow representing one or more implementations or versions of the task information exposition technique does not inherently indicate any particular order nor imply any limitations of the task information exposition technique.

As utilized herein, the terms “component,” “system,” “client” and the like are intended to refer to a computer-related entity, either hardware, software (e.g., in execution), firmware, or a combination thereof. For example, a component can be a process running on a processor, an object, an executable, a program, a function, a library, a subroutine, a computer, or a combination of software and hardware. By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, to the extent that the terms “includes,” “including,” “has,” “contains,” variants thereof, and other similar words are used in either this detailed description or the claims, these terms are intended to be inclusive, in a manner similar to the term “comprising”, as an open transition word without precluding any additional or other elements.

### 1.0 Electronic Messaging and Online Services

As described heretofore, people today heavily rely on electronic messages to communicate with each other in both a professional and a personal context. As is appreciated in the art of electronic messaging over data communication networks, people today routinely exchange various types of electronic messages with each other including, but not limited to, email (also known as electronic mail and e-mail) messages, instant text messages (also known as SMS (Short Message Service) messages), instant multimedia messages (also known as MMS (Multimedia Messaging Service) messages), online chat messages (also known as instant messaging (IM), among other things), recorded voice messages (e.g., recorded phone calls and the like), recorded video messages (e.g., recorded video calls and the like), blog postings on the World Wide Web (hereafter simply referred to as the Web), user postings on social networking websites, and fax (also known as facsimile or telefax) messages. The term “user” is used herein to refer to a person who is using the task information exposition technique implementations described herein. In the course of the just-described communication via electronic messages one or more tasks are often discussed between a plurality of people, and the responsibility for completing a given task is often assigned to one or more of the people who are involved in this discussion.

As also described heretofore, people today also routinely use (e.g., interact with) a variety of the online services that are available on the Internet. The term “online service” is used herein to refer to a given software-based service or application that is provided over a data communication network to a person who is using an end-user computing device by one or more other computing devices, where the software-based service provides one or more functions that may assist the person in completing a given task. The term “service provider” is used herein to refer to a provider of one or more online services. As is appreciated in the arts of the Internet and the Web, a vast number of online services exist today which are offered by a vast number of service providers. In the course of a given day a given person commonly uses numerous different online services to complete various tasks. By way of example but not limitation, a person who wants to book (e.g., buy or reserve) tickets to see a movie may use a conventional online movie ticket purchasing service that either is offered by a service provider which is associated with a particular movie theater or chain thereof (e.g., www.amctheatres.com, or www.regmovies.com, among many others), or is offered by a service provider which does not have such an association but rather offers tickets for any movie theater (e.g., www.movietickets.com, or www.fandango.com, among many others). A person who wants to book tickets for an airline flight may use a conventional online flight ticket purchasing service that either is offered by a service provider which is associated with a particular airline (e.g., www.aa.com, or www.united.com, among many others), or is offered by a service provider which does not have such an association but rather offers tickets for any airline (e.g., www.expedia.com, or www.travelocity.com, among many others). A person who wants to book a reservation for a hotel room may use a conventional online hotel room reservation service that either is offered by a service provider which is associated with a particular hotel or chain thereof (e.g., www.marriott.com, or www3.hilton.com, among many others), or is offered by a service provider which does not have such an association but rather offers reservations for any hotel (e.g., www.expedia.com, or www.travelocity.com, among many others).

### 2.0 Exposing Task Information to Online Service Providers

The task information exposition technique implementations described herein generally involve exposing task information to online service providers. More particularly and as will be appreciated from the more-detailed description that follows, in one implementation of the task information exposition technique described herein task intents in a dataset of electronic messages are automatically identified, where each of the identified task intents is a specific task that is to be completed. Then, for each of the identified task intents, one or more service providers are automatically identified, where each of these identified service providers offers one or more online services that are capable of assisting in the fulfillment of the identified task intent. Then, for each of the identified task intents, information (e.g., metadata) associated with the identified task intent (e.g., information about the task intent) is automatically exposed to each of the identified service providers that offers one or more online services that are capable of assisting in the fulfillment of the identified task intent. Other implementations of the task information exposition technique are also described in more detail hereafter.

The task information exposition technique implementations described herein are advantageous for various reasons including, but not limited to, the following. As will be appreciated from the foregoing and the more-detailed description that follows, the task information exposition technique implementations are operable with any type of online service that is provided by any type of service provider. The task information exposition technique implementations can also be employed in a wide variety of computing (e.g., software-based) applications. For example, the task information exposition technique implementations can be employed in any type of conventional intelligent personal assistant computing application such as SIRI® (a registered trademark of Apple Inc.) and CORTANA® (a registered trademark of Microsoft Corporation), among others. Additionally, the task information exposition technique implementations increase user efficiency and productivity by automatically mapping task intents that are expressed in electronic messages to online services that can assist in the fulfillment of the task intents (e.g., the task information exposition technique implementations assist in the completion of the specific tasks that are associated with the task intents). More particularly and by way of example but not limitation, the task information exposition technique implementations automatically identify a given task intent that is mentioned in the electronic messages which are communicated between people, and automatically identify a person who is mentioned in the electronic messages and is assigned to fulfill the identified task intent, and automatically identify service providers who offer online services that are capable of assisting the identified person in the fulfillment of the identified task intent. As such, the task information exposition technique implementations increase the speed at which the identified person is able to complete the specific task that is associated with the identified task intent, and minimize the effort the identified person has to expend to complete this task. The task information exposition technique implementations also automatically learn various preferences of the identified person and may automatically expose appropriate ones of these personal preferences to a given service provider that the identified person selects to assist them in fulfilling the identified task intent.

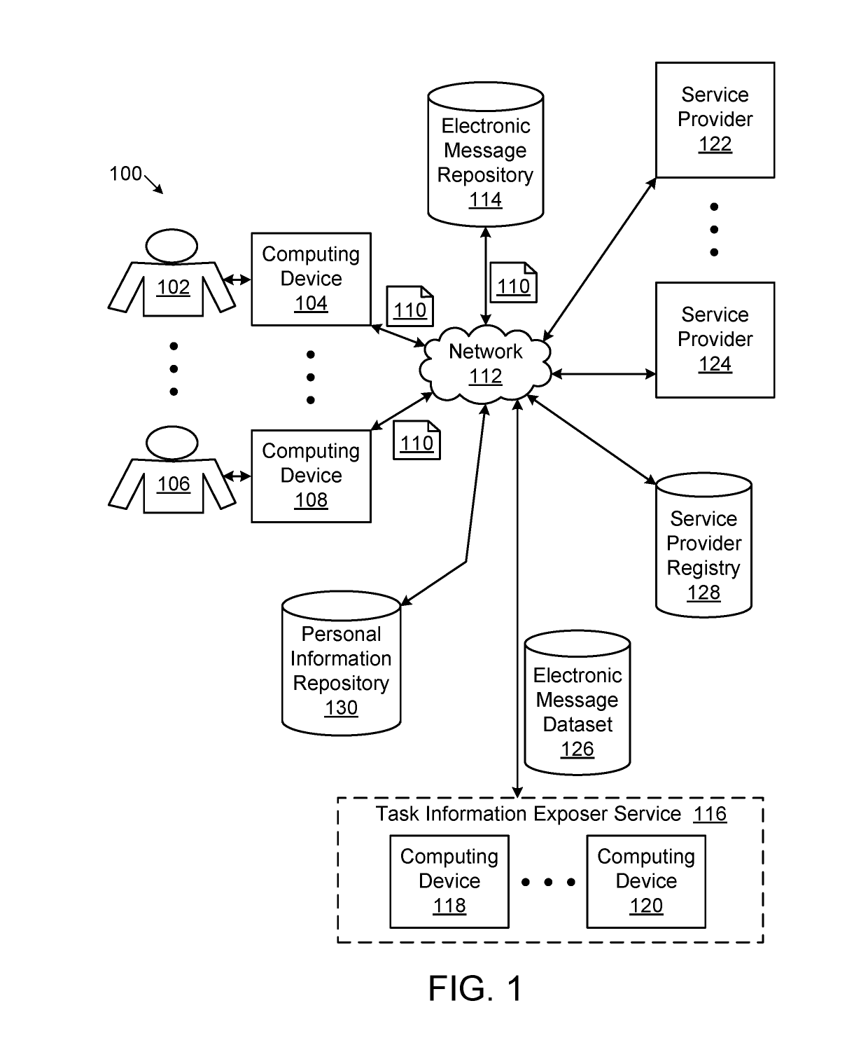

FIG. 1 illustrates an exemplary implementation, in simplified form, of a system framework for realizing the task information exposition technique implementations described herein. As exemplified in FIG. 1, the system framework 100 includes one or more end-user computing devices 104/108 each of which is utilized by one or more people 102/106 to communicate electronic messages 110 between themselves 102/106. Exemplary types of electronic messages 110 that may be communicated between the people 102/106 are described in more detail hereafter. Each of the end-user computing devices 104/108 can be any type of conventional mobile computing device such as a smartphone, or a tablet computer, or a laptop computer (sometimes also referred to as a notebook or netbook computer), or a computing device that is integrated into an automobile, among other types of conventional mobile computing devices. Each of the end-user computing devices 104/108 can also be any type of conventional non-mobile computing device such as a desktop personal computer (PC), or a video game console, among other types of conventional non-mobile computing devices.

Referring again to FIG. 1, each of the end-user computing devices 104/108 is configured to communicate over a conventional data communication network 112 (herein also referred to as a computer network) such as the Internet (among other types of conventional data communication networks) with a personal information repository 130 and an electronic message repository 114. The personal information repository 130 stores various types of personal information that is learned about each of the people 102/106 that uses the task information exposition technique implementations described herein. Exemplary types of personal information that may be learned about the people 102/106 are described in more detail hereafter. The personal information repository 130 can be realized in various ways. For example, the personal information repository 130 may be a custom database that is dedicated to the task information exposition technique implementations. The personal information repository 130 may also be one or more conventional databases that are managed by conventional applications such as a personal information management application or an intelligent personal assistant computing application, among others. The personal information repository 130 may also be a combination of the just-described custom database and conventional databases.

Referring again to FIG. 1, the electronic message repository 114 stores the electronic messages 110 which are communicated between the people 102/106. The task information exposition technique implementations support the communication of any type of electronic message 110 between the people 102/106. By way of example but not limitation, in one implementation of the task information exposition technique described herein the electronic messages 110 that are communicated between the people 102/106 and stored in the repository 114 include one or more email (also known as electronic mail and e-mail) messages which may include one or more email threads. As is appreciated in the art of email messaging, an email thread is an email message that includes a chronologically-ordered concatenation of an original email message and each of the succeeding replies thereto. Accordingly, an email thread provides a chronologically-ordered record of an email-based conversation that takes place between a plurality of people. In another implementation the electronic messages 110 may include one or more instant text messages, or one or more instant multimedia messages, or one or more online chat messages. In another implementation the messages 110 may include one or more recorded voice messages that have been converted to text using a conventional speech-to-text (also known as voice-to-text) conversion method, or one or more recorded video messages having audio that has been converted to text using the speech-to-text conversion method. In another implementation the messages 110 may include one or more web-based (e.g., online) blog postings, or one or more user postings on one or more social networking websites. In another implementation the messages 110 may include one or more fax messages that have been converted to text using a conventional optical character recognition method. In another implementation the messages 110 may include any combination of the just-described different types of electronic messages.

Referring again to FIG. 1, the end-user computing devices 104/108, electronic message repository 114, and personal information repository 130 are also configured to communicate over the data communication network 112 with a task information exposer service 116 that runs on one or more other computing devices 118/120. These other computing devices 118/120 can also communicate with each other via the network 112. In an exemplary implementation of the task information exposition technique described herein the other computing devices 118/120 are located in the cloud so that the exposer service 116 operates as a cloud service and the network 112 includes wide area network functionality. The term “cloud service” is used herein to refer to a web application that operates in the cloud and can be hosted on (e.g., deployed at) a plurality of data centers that can be located in different geographic regions (e.g., different regions of the world).

Referring again to FIG. 1 and as will be described in more detail hereafter, the task information exposer service 116 generally performs a variety of functions associated with exposing task information over the data communication network 112 to one or more service providers 122/124. By way of example but not limitation, the exposer service 116 receives a dataset 126 from the electronic message repository 114 that includes one or more of the electronic messages 110 that are communicated between the people 102/106 and stored in the repository 114. The exposer service 116 then automatically identifies task intents in the dataset 126, where each of the identified task intents is a specific task that is to be completed. Then, for each of the task intents that is identified in the dataset 126, the exposer service 116 automatically identifies one or more service providers 122/124 each of whom offers one or more online services that are capable of assisting in the fulfillment of the identified task intent. Then, for each of the task intents that is identified in the dataset 126, the exposer service 116 automatically exposes information associated with the identified task intent to each of the identified service providers 122/124 that offers one or more online services that are capable of assisting in the fulfillment of the identified task intent. As will be appreciated from the more detailed description of the task information exposition technique implementations that is provided herein, the identified service providers 122/124 who offer online services which are capable of assisting in the fulfillment of a given identified task intent may use the various types of information that are exposed to them to scope the experience they render to the person who is assigned to fulfill the task intent, and help this person to optimize the fulfillment of the task intent. In one implementation of the task information exposition technique described herein each of the service providers 122/124 is an entity that is independent of the entity that is operating the task information exposer service 116 (e.g., each of the services providers is a third-party service provider). In another implementation of the task information exposition technique one of the service providers 122/124 may be the same entity that is operating the task information exposer service 116.

Referring again to FIG. 1, the system framework 100 also includes a service provider registry 128 that can be accessed via the data communication network 112. The registry 128 generally maps pre-defined task intents to service providers 122/124 that have registered as offering online services that are capable of assisting in the fulfillment of the task intents. More particularly, in an exemplary implementation of the task information exposition technique described herein the registry 128 includes a prescribed list of task intents, where each of the task intents in the list are mapped to one or more registered service providers (e.g. service provider 122) each of whom offers one or more online services that are capable of assisting in the fulfillment of the task intent in the list. It is noted that a given service provider may register for more than one task intent. For example, a given service provider who offers a variety of different movie-related online services may register as offering an online service that allows people to book movie tickets, and another online service that allows people to rent movies, and yet another online service that provides people with movie reviews. A given service provider may also register a given online service as being able to fulfill a plurality of task intents. It is further noted that when a given service provider registers as offering one or more online services that are capable of assisting in the fulfillment of a given task intent, the service provider may request that one or more specific types of information related to the task intent be provided to the service provider in order for the service provider to be able to assist in the fulfillment of the task intent. In this case the registry 128 will specify the specific types of information related to the task intent that the service provider requested be provided thereto. For example, in the case where a service provider who offers an online flight ticket purchasing service registers for the “book flight” task intent, this service provider may request that information regarding the traveler's departure and return dates, the city/airport they would like to depart from, and the city/airport they would like to travel to, and their seating and meal preferences be provided to the service provider. In the case where a service provider who offers an online hotel room reservation service registers for the “book hotel” task intent, this service provider may request that information regarding the traveler's check-in and check-out dates, and number of rooms desired be provided to the service provider.

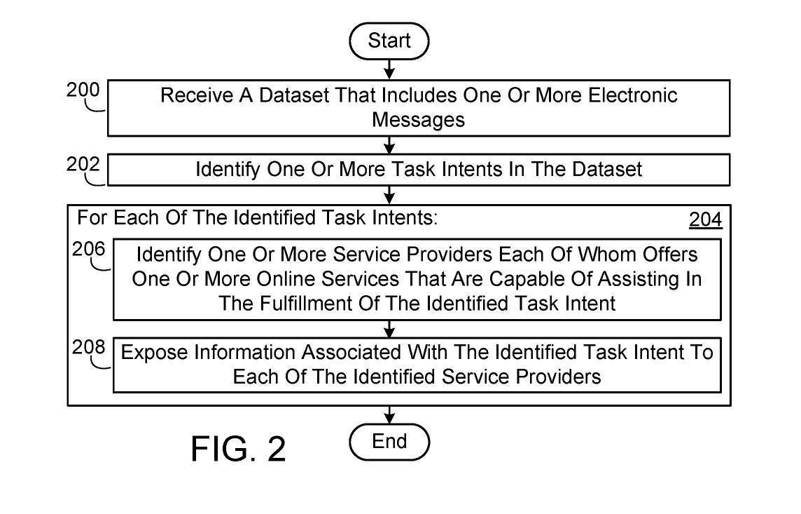

FIG. 2 illustrates one implementation, in simplified form, of a process for exposing task information. In an exemplary implementation of the task information exposition technique described herein the process illustrated in FIG. 2 is realized on the system framework 100 illustrated in FIG. 1. As exemplified in FIG. 2, the process starts with receiving a dataset that includes one or more electronic messages (process action 200). Exemplary types of electronic messages that can be included in this dataset have been described heretofore. In an exemplary implementation of the task information exposition technique the dataset is received from the aforementioned electronic message repository, and the electronic messages in the dataset are associated with a conversation between a plurality of people. After the dataset has been received (action 200), one or more task intents in the dataset are identified (process action 202), where each of these identified task intents is a specific task that is to be completed. It is noted that each of the identified task intents may be either confirmed or unconfirmed, where confirmed identified task intents may be either implicitly or explicitly confirmed. It will be appreciated that this task intent identification (action 202) can be performed in various ways. In an exemplary implementation of the task information exposition technique the task intent identification of action 202 is performed using a conventional parsing method to extract sentences from the dataset, and then using conventional natural language processing and machine learning methods to identify any task intents in each of the extracted sentences. For example, such methods have shown the ability to successfully extract commitments that are made to others, requests that are made by others, and action items that are assigned to others.

Referring again to FIG. 2, after the task intents in the dataset have been identified (action 202), the following actions are completed for each of the task intents that is identified (process action 204). First, one or more service providers are identified, where each of the identified service providers offers one or more online services that are capable of assisting in the fulfillment of the identified task intent (process action 206). Then, information associated with the identified task intent is exposed to each of the identified service providers (process action 208). Examples of such information that may be exposed and various operational scenarios in which it is exposed are described in more detail in other portions of this section. In an exemplary implementation of the task information exposition technique described herein the just-described service provider identification (action 206) is realized as follows. Whenever the identified task intent exists in the aforementioned list of task intents that is stored in the service provider registry, the one or more registered service providers that are mapped to the identified task intent are assigned to be the identified service providers.

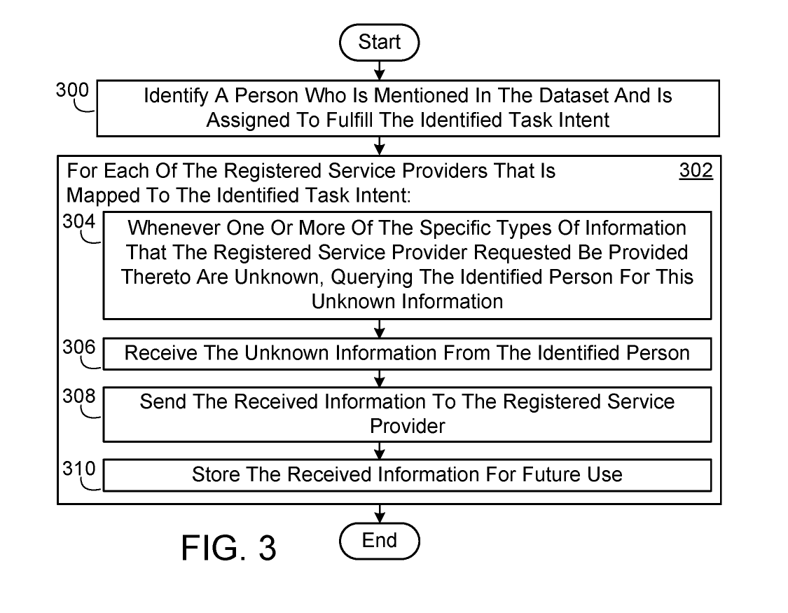

FIG. 3 illustrates one implementation, in simplified form, of a process for exposing information associated with the identified task intent to each of the identified service providers. In other words, FIG. 3 illustrates one implementation of the action 208 that is shown in FIG. 2. As exemplified in FIG. 3, the process starts with identifying a person who is mentioned in the dataset and is assigned to fulfill the identified task intent (process action 300—e.g., the identified person is responsible for completing the specific task that is associated with the identified task intent). It is noted that a given person can be mentioned in the dataset in various ways. For example, a given person (e.g., “John Smith”) can be mentioned in the dataset by just their first name (“John”), or a combination of their first name and last name (“John Smith”), or a combination of their first initial and last name (“J. Smith”), or a combination of their first name and last initial (“John S.”), or just their last name (“Smith”), or their nickname (e.g., “jman”), or an alias (e.g., “jsmith”), or one or more of their email addresses (e.g., “jsmith@contoso.com”), among other possible ways of identifying a person. It is further noted that the person who is identified as being assigned to fulfill the identified task intent may be the sender of one or more messages in the dataset, or the receiver of one or more messages in the dataset, or may be called out in the body of one or more messages in the dataset. It will be appreciated that this mentioned person identification (action 300) can be performed in various ways. In an exemplary implementation of the task information exposition technique described herein the mentioned person identification of action 300 is performed using a conventional parsing method in combination with conventional natural language processing and machine learning methods.

As described heretofore, for each of the registered service providers that is mapped to each of the task intents in the list of task intents that is stored in the service provider registry, the registry specifies any specific types of information related to the task intent that the registered service provider requested be provided to the service provider in order for the service provider to be able to assist in the fulfillment of the task intent in this list. Referring again to FIG. 3, after the person who is mentioned in the dataset and is assigned to fulfill the identified task intent has been identified (action 300), the following actions occur for each of the registered service providers that is mapped to the identified task intent (process action 302). Whenever one or more of the specific types of information that the registered service provider requested be provided thereto are unknown, the identified person is queried for this unknown information (process action 304—e.g., a request to provide the unknown information is sent to the identified person). Upon receiving the unknown information from the identified person (process action 306), it is sent to the registered service provider (process action 308), and it may also be stored for future use (process action 310). In an exemplary implementation of the task information exposition technique described herein the just-described querying of the identified person for the unknown information (action 304) can optionally include the action of asking the identified person to consent to exposing (e.g., provide their permission to expose) this unknown information to the registered service provider. Once this consent is received from the identified person it can optionally be stored for future use.

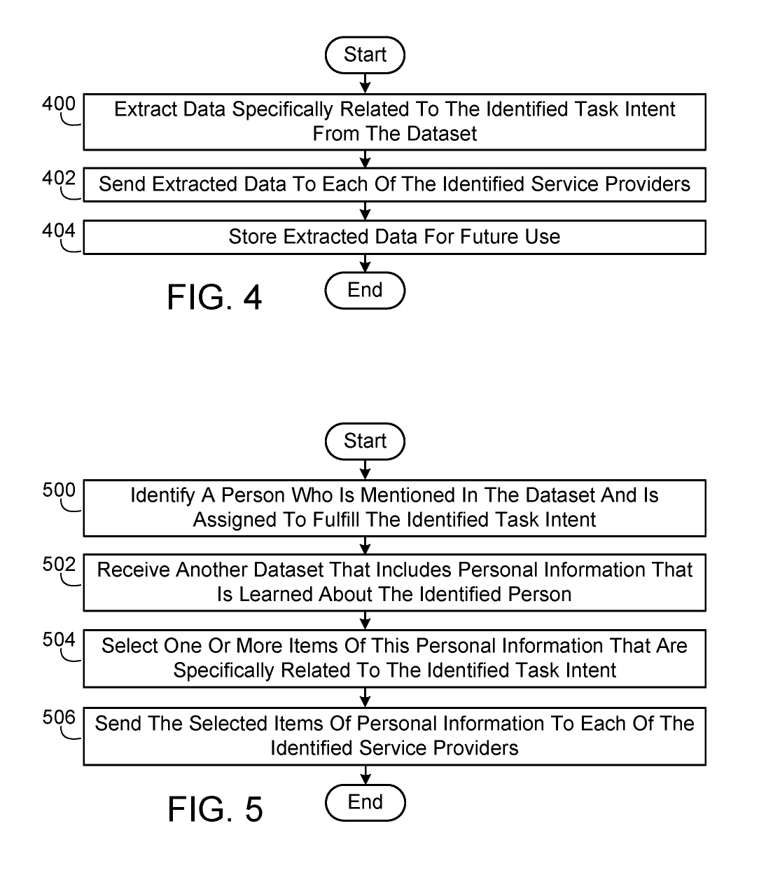

FIG. 4 illustrates another implementation, in simplified form, of a process for exposing information associated with the identified task intent to each of the identified service providers. In other words, FIG. 4 illustrates another implementation of the action 208 that is shown in FIG. 2. As exemplified in FIG. 4, the process starts with automatically extracting data specifically related to the identified task intent from the dataset (process action 400). It will be appreciated that this data extraction (action 400) can be performed in various ways. In an exemplary implementation of the task information exposition technique described herein the data extraction of action 400 is performed using a conventional parsing method in combination with conventional natural language processing and machine learning methods. It is noted that the task information exposition technique implementations described herein can extract any type of data that is specifically related to any type of task intent from the dataset. For example, in the case where the dataset includes an electronic message that states “I will book tickets for this Friday's showing of the XYZ movie at the ABC theater in Redmond” the task information exposition technique implementations will identify the task intent to be “book movie tickets”, and will extract “this Friday”, “XYZ” and “ABC theater in Redmond” as being the data that is specifically related to this identified task intent. In the case where the dataset includes an electronic message that states “can you book me a flight from Los Angeles to Houston next Monday” the task information exposition technique implementations will identify the task intent to be “book flight”, and will extract “Los Angeles to Houston” and “next Monday” as being the data that is specifically related to this identified task intent. After the data specifically related to the identified task intent has been extracted from the dataset (action 400), this extracted data is sent to each of the identified service providers (process action 402) and may also be stored for future use (process action 404).

FIG. 5 illustrates yet another implementation, in simplified form, of a process for exposing information associated with the identified task intent to each of the identified service providers. In other words, FIG. 5 illustrates yet another implementation of the action 208 that is shown in FIG. 2. As exemplified in FIG. 5, the process starts with identifying a person who is mentioned in the dataset and is assigned to fulfill the identified task intent (process action 500). Another dataset is then received that includes personal information that is learned (e.g., information that is already known) about the identified person (process action 502). In an exemplary implementation of the task information exposition technique described herein this dataset is received from the aforementioned personal information repository. One or more items of this personal information that are specifically related to the identified task intent are then selected (process action 504), and the selected items of personal information are sent to each of the identified service providers (process action 506). In an exemplary implementation of the task information exposition technique the just-described personal information selection (action 504) can optionally include the action of asking the identified person to consent to exposing the selected items of personal information to the identified service providers. Once this consent is received from the identified person it can optionally be stored for future use. Generally speaking and as will be described in more detail hereafter, the task information exposition technique implementations described herein will continuously learn various types of personal information about each of the people that uses the task information exposition technique implementations, and will automatically apply this learned information to future task intents that are identified. It is noted that the task information exposition technique implementations can learn any type of personal information about the identified person, examples of which will now be described in more detail.

In one implementation of the task information exposition technique described herein the personal information that is learned about the identified person includes the geographic location where the identified person lives (e.g., the geographic location of the identified person's home). In another implementation the personal information that is learned about the identified person includes the geographic location where the identified person works (e.g., the geographic location of the identified person's place of work). In yet another implementation the personal information that is learned about the identified person includes one or more commute characteristics for the identified person (e.g., what time the identified person typically leaves home to travel to work, what time they typically arrive at work, what time they typically leave work to travel home, what time they typically arrive back at home, and the like). In yet another implementation the personal information that is learned about the identified person includes personal preferences of the identified person (e.g., the identified person's food and cuisine preferences, and their seating preference for airline travel, movies, theater, and the like, among other types of personal preferences). In yet another implementation the personal information that is learned about the identified person includes information about the identified person that is subject to change over time (e.g., over the course of a given day); examples of such information are described in more detail hereafter. In yet another implementation the personal information that is learned about the identified person includes personal contacts of the identified person. In yet another implementation the personal information that is learned about the identified person includes professional contacts of the identified person. It will be appreciated that both the personal and professional contacts of a given person can be determined from a conventional contacts database that is maintained by any one of a variety of conventional personal information management applications. In yet another implementation the personal information that is learned about the identified person includes a prescribed identifier for the identified person (e.g., the person's name, or their email address, among other types of personal identifiers). In yet another implementation the personal information that is learned about the identified person may include any combination of the just-described different types of personal information.

It will be appreciated that there are many different types of information about the identified person that is subject to change over time. By way of example but not limitation, the information about the identified person that is subject to change over time may include the current geographic location of the identified person. The information about the identified person that is subject to change over time may also include the time zone where the identified person is currently located (which may serve as a proxy for the identified person's current location). The information about the identified person that is subject to change over time may also include one or more of the skills of the identified person, or the interests of the identified person, or the experience of the identified person (and hence the identified person's motivation and ability to complete the specific task associated with the identified task intent). The information about the identified person that is subject to change over time may also include information that is related to an upcoming meeting the identified person is scheduled to attend (e.g., the title/subject of the meeting, the location of the meeting, the scheduled start time for the meeting, the scheduled end time for the meeting, other people who are scheduled to attend the meeting, a link to an online meeting service (also known as a web conferencing service) that may be used for the meeting (e.g., www.gotomeeting.com, or www.skype.com, or the like), or any combination thereof). The information about the identified person that is subject to change over time may also include various other contextual factors.

Referring again to FIG. 2, after the information associated with the identified task intent has been exposed to a given identified service provider (action 208), a variety of things can happen. By way of example but not limitation, in one implementation of the task information exposition technique described herein the identified service provider may interact directly with the identified person who is assigned to fulfill the identified task intent (e.g., the service provider may provide the identified person with a link (e.g., a Uniform Resource Locator (URL), also known as a web address) to one or more online services that the identified person can utilize to fulfill the identified task intent. Other implementations of the task information exposition technique are also possible where the task information exposition technique functions as an intermediary between the identified service provider and the identified person. Examples of such other implementations will now be described in more detail.

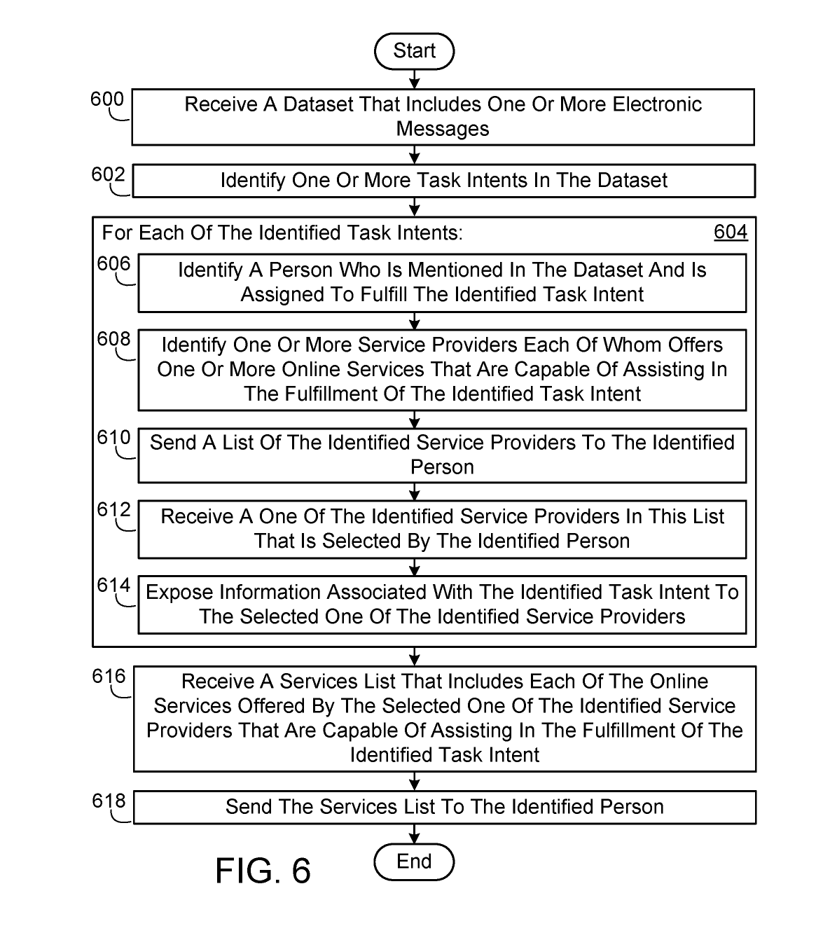

FIG. 6 illustrates another implementation, in simplified form, of a process for exposing task information. In an exemplary implementation of the task information exposition technique described herein the process illustrated in FIG. 6 is realized on the system framework 100 illustrated in FIG. 1. As exemplified in FIG. 6, the process starts with receiving a dataset that includes one or more electronic messages (process action 600), and then identifying one or more task intents in the dataset (process action 602), where each of these identified task intents is a specific task that is to be completed. As described heretofore, each of the identified task intents may be either confirmed or unconfirmed, where confirmed identified task intents may be either implicitly or explicitly confirmed. After the task intents in the dataset have been identified (action 602), the following actions are completed for each of the task intents that is identified (process action 604). First, a person who is mentioned in the dataset and is assigned to fulfill the identified task intent is identified (process action 606). One or more service providers are then identified, where each of the identified service providers offers one or more online services that are capable of assisting in the fulfillment of the identified task intent (process action 608). A list of the identified service providers is then sent to the identified person (process action 610), and they may select a desired one of the service providers in the list that they want to use to fulfill the identified task intent. Upon the identified person selecting one of the identified service providers in the list that was sent to them, the one of the identified service providers that is selected by the identified person is received (process action 612), and information associated with the identified task intent is exposed to the selected one of the identified service providers (process action 614). A services list that includes each of the online services offered by the selected one of the identified service providers that are capable of assisting in the fulfillment of the identified task intent is then received from the selected one of the identified service providers (process action 616), and this services list is sent to the identified person (process action 618).

It is noted that the just-described action of sending a list of the identified service providers to the identified person (action 610) can be implemented in various ways, examples of which will now be described in more detail.

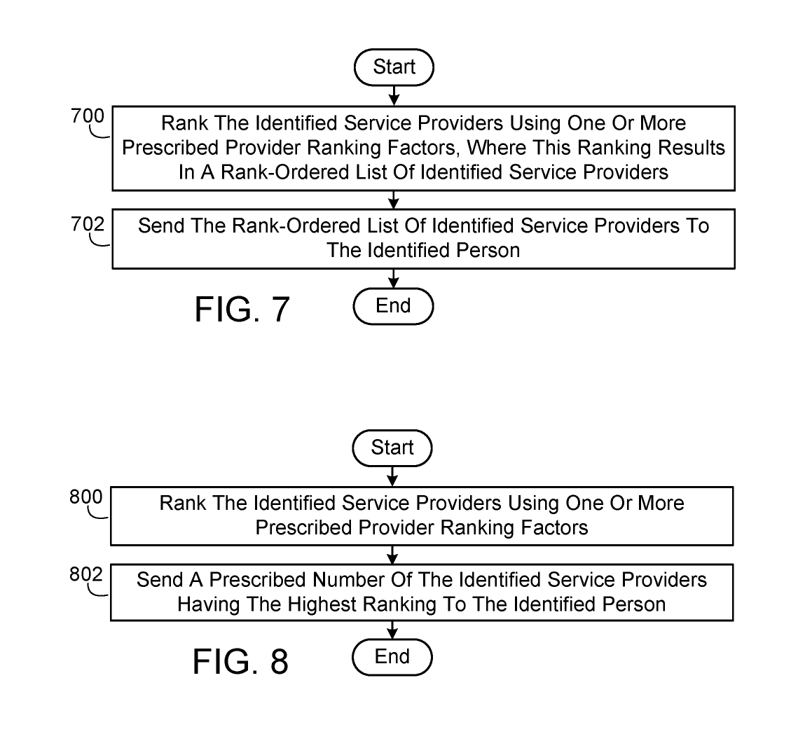

FIG. 7 illustrates one implementation, in simplified form, of a process for sending a list of the identified service providers to the identified person whenever the identified service providers include a plurality of service providers. In other words, FIG. 7 illustrates one implementation of the action 610 that is shown in FIG. 6. As exemplified in FIG. 7, the process starts with ranking the identified service providers using one or more prescribed provider ranking factors, where this ranking results in a rank-ordered list of identified service providers (process action 700). The rank-ordered list of identified service providers is then sent to the identified person (process action 702). The task information exposition technique implementations described herein can employ a variety of provider ranking factors. By way of example but not limitation, the identified service providers can be ranked according to their relevance to the identified task intent. The identified service providers can also be ranked according to how often they have been used in the past, either by the identified person themselves, or by the aggregate of all of people who use the task information exposition technique implementations. The identified service providers can also be ranked according to other personal and/or contextual data. The ranking can also employ a combination of different ranking factors, in which case each of the ranking factors that is employed may be weighted according to its relevance to the identified task intent. It will thus be appreciated that the task information exposition technique implementations employ an intelligent service provider ranking method that continuously learns people's online service preferences.

FIG. 8 illustrates another implementation, in simplified form, of a process for sending a list of the identified service providers to the identified person whenever the identified service providers include a plurality of service providers. In other words, FIG. 8 illustrates another implementation of the action 610 that is shown in FIG. 6. As exemplified in FIG. 8, the process starts with ranking the identified service providers using one or more prescribed provider ranking factors (process action 800). A prescribed number of the identified service providers having the highest ranking are then sent to the identified person (process action 802). This prescribed number can be one (such that just the highest-ranked identified service provider is sent), or the prescribed number can be a small number greater than one (e.g., two, or three, or four). It will be appreciated that the utility of the implementation described in this paragraph is generally dependent on the type of task intent that is identified (e.g., for some types of task intents the online services that are offered by the identified service providers are easily substitutable, whereas for other types of task intents the identified person may want to play an active role in deciding which of the identified service providers is selected).

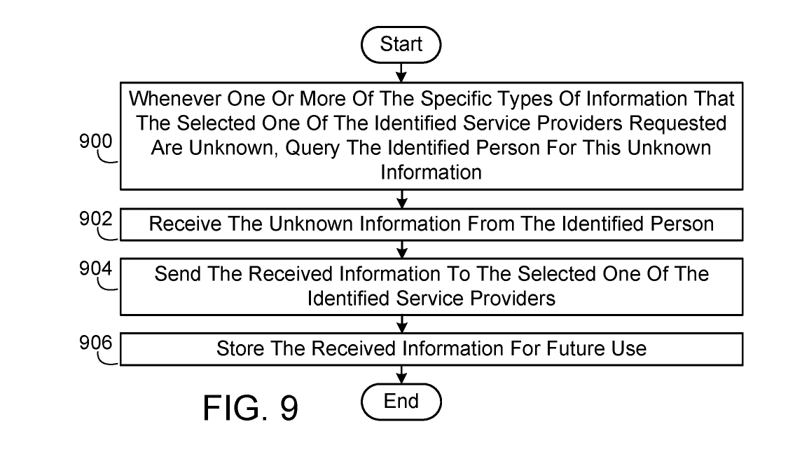

FIG. 9 illustrates an exemplary implementation, in simplified form, of a process for exposing information associated with the identified task intent to the selected one of the identified service providers in the case where the selected one of the identified service providers requested that one or more specific types of information be provided to this selected provider in order for this selected provider to be able to assist in the fulfillment of the identified task intent. In other words, FIG. 9 illustrates an exemplary implementation of the action 614 that is shown in FIG. 6. As exemplified in FIG. 9, the process starts with, whenever one or more of the specific types of information that the selected one of the identified service providers requested are unknown, querying (e.g., sending a request to) the identified person for this unknown information (process action 900). Upon receiving the unknown information from the identified person (process action 902), the received information is sent to the selected one of the identified service providers (process action 904), and the received information may also be stored for future use (process action 906).

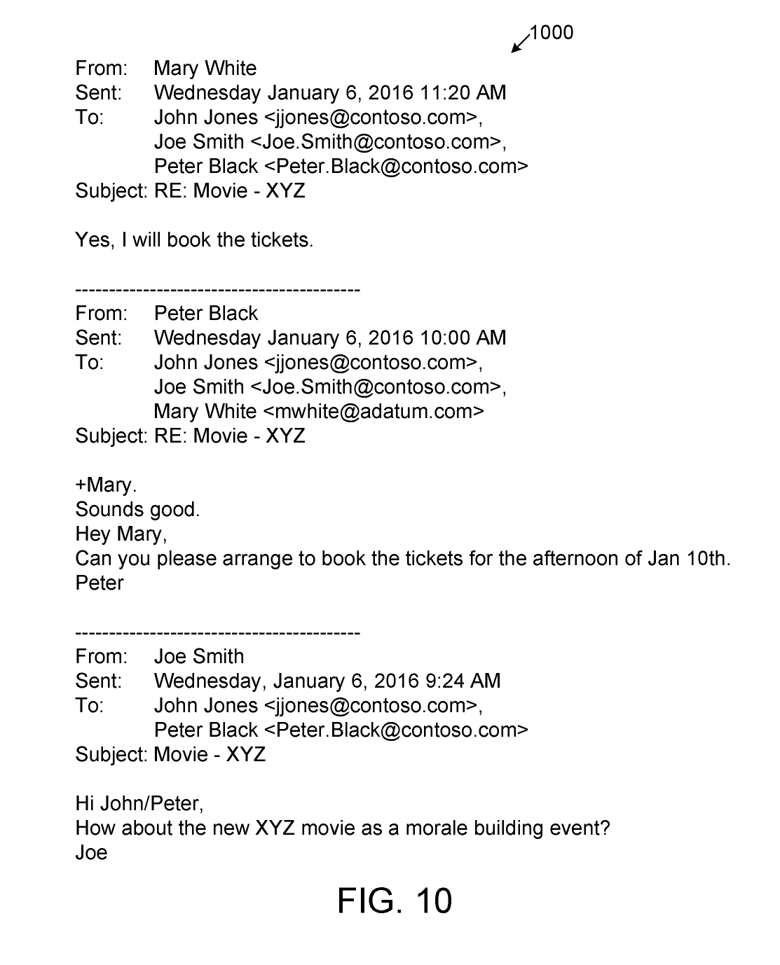

FIG. 10 illustrates an exemplary implementation, in simplified form, of an email thread that is communicated between a plurality of people, namely “Joe Smith”, “John Jones”, “Peter Black” and “Mary White”. In the case where the email thread 1000 shown in FIG. 10 is included in the dataset of electronic messages, and the “book movie tickets” task intent exists in the service provider registry and is mapped to www.movietickets.com and www.fandango.com both of whom have registered as offering online services that can assist in the fulfillment of this task intent, one implementation of the task information exposition technique described herein will operate as follows. The task information exposition technique will receive the thread 1000 and will identify “book movie tickets” as a task intent in the thread. The task information exposition technique will also identify “Mary White” as the person who is mentioned in the thread 1000 and is assigned to fulfill the “book movie tickets” task intent. The task information exposition technique will also extract “XYZ” and “afternoon of January 10^{th}” as being data that is specifically related to the “book movie tickets” task intent, and will send this extracted data to both www.movietickets.com and www.fandango.com.

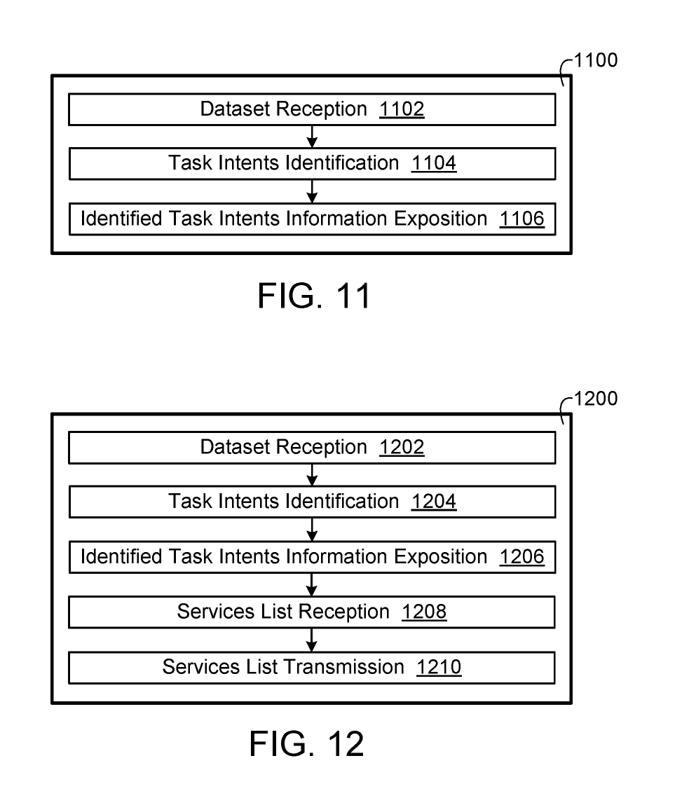

FIG. 11 illustrates one implementation, in simplified form, of a task information exposer computer program for exposing task information. As exemplified in FIG. 11 and referring again to FIG. 2, the task information exposer computer program 1100 includes, but is not limited to, a dataset reception sub-program 1102 that performs action 200, a task intents identification sub-program 1104 that performs action 202, and an identified task intents information exposition sub-program that performs action 204 and its corresponding actions 206 and 208. Each of the just-described sub-programs is realized on a computing device such as that which is described in more detail in the Exemplary Operating Environments section which follows. More particularly and by way of example but not limitation, and referring again to FIG. 1, in one implementation of the task assignment identification technique described herein the just-described sub-programs may be realized on the computing devices 118/120.

FIG. 12 illustrates another implementation, in simplified form, of a task information exposer computer program for exposing task information. As exemplified in FIG. 12 and referring again to FIG. 6, the task information exposer computer program 1200 includes, but is not limited to, a dataset reception sub-program 1202 that performs action 600, a task intents identification sub-program 1204 that performs action 602, an identified task intents information exposition sub-program that performs action 604 (along with its corresponding actions 606, 608, 610, 612 and 614), a services list reception sub-program 1208 that performs action 616, and a services list transmission sub-program 1210 that performs action 618. Each of the just-described sub-programs is realized on a computing device such as that which is described in more detail in the Exemplary Operating Environments section which follows. More particularly and by way of example but not limitation, and referring again to FIG. 1, in one implementation of the task assignment identification technique described herein the just-described sub-programs may be realized on the computing devices 118/120.

### 3.0 Other Implementations

While the task information exposition technique has been described by specific reference to implementations thereof, it is understood that variations and modifications thereof can be made without departing from the true spirit and scope of the task information exposition technique. By way of example but not limitation and referring again to FIG. 6, in the case where action 608 indentifies a plurality of service providers who offer online services that are capable of assisting in the fulfillment of a given identified task intent, rather than performing actions 610 and 612 (i.e., rather than relying on the identified person to select one of the identified service providers) an alternate implementation of action 614 is possible where information associated with the identified task intent is automatically exposed to a highest ranking one of the identified service providers. This particular implementation may be useful for certain types of task intents. Another alternate implementation of action 614 is also possible where the identified person has previously indicated a preference for a particular one of the plurality of identified service providers for a given identified task intent, this user preference has been stored for future use, and information associated with the identified task intent is automatically exposed to this preferred one of the identified service providers.

It is noted that any or all of the aforementioned implementations throughout the description may be used in any combination desired to form additional hybrid implementations. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What has been described above includes example implementations. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of the appended claims.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the foregoing implementations include a system as well as a computer-readable storage media having computer-executable instructions for performing the acts and/or events of the various methods of the claimed subject matter.

There are multiple ways of realizing the foregoing implementations (such as an appropriate application programming interface (API), tool kit, driver code, operating system, control, standalone or downloadable software object, or the like), which enable applications and services to use the implementations described herein. The claimed subject matter contemplates this use from the standpoint of an API (or other software object), as well as from the standpoint of a software or hardware object that operates according to the implementations set forth herein. Thus, various implementations described herein may have aspects that are wholly in hardware, or partly in hardware and partly in software, or wholly in software.

The aforementioned systems have been described with respect to interaction between several components. It will be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (e.g., hierarchical components).

Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

### 4.0 Exemplary Operating Environments

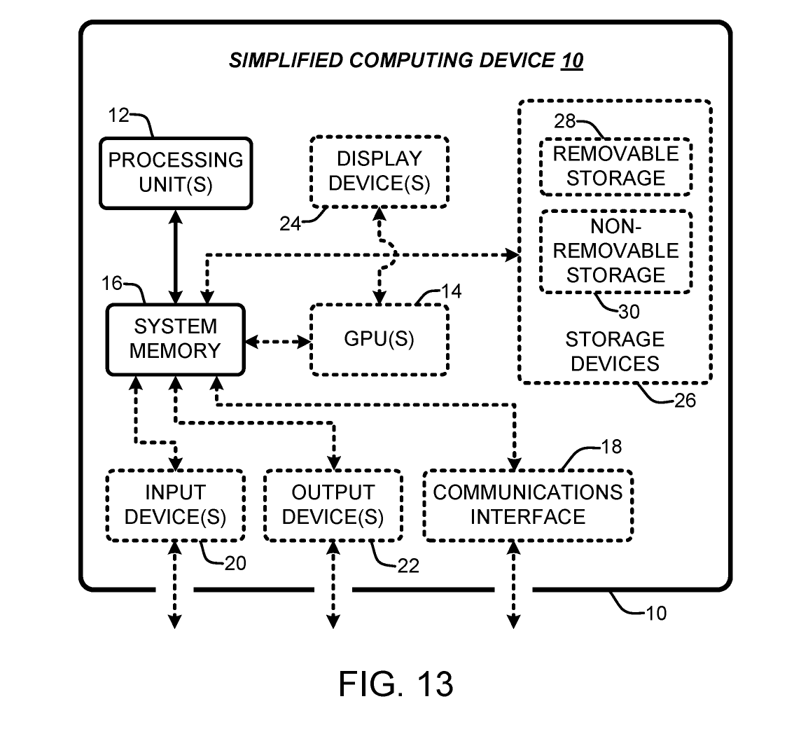

The task information exposition technique implementations described herein are operational within numerous types of general purpose or special purpose computing system environments or configurations. FIG. 13 illustrates a simplified example of a general-purpose computer system on which various implementations and elements of the task information exposition technique, as described herein, may be implemented. It is noted that any boxes that are represented by broken or dashed lines in the simplified computing device 10 shown in FIG. 13 represent alternate implementations of the simplified computing device. As described below, any or all of these alternate implementations may be used in combination with other alternate implementations that are described throughout this document. The simplified computing device 10 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to realize the task information exposition technique implementations described herein, the device should have a sufficient computational capability and system memory to enable basic computational operations. In particular, the computational capability of the simplified computing device 10 shown in FIG. 13 is generally illustrated by one or more processing unit(s) 12, and may also include one or more graphics processing units (GPUs) 14, either or both in communication with system memory 16. Note that that the processing unit(s) 12 of the simplified computing device 10 may be specialized microprocessors (such as a digital signal processor (DSP), a very long instruction word (VLIW) processor, a field-programmable gate array (FPGA), or other micro-controller) or can be conventional central processing units (CPUs) having one or more processing cores.

In addition, the simplified computing device 10 may also include other components, such as, for example, a communications interface 18. The simplified computing device 10 may also include one or more conventional computer input devices 20 (e.g., touchscreens, touch-sensitive surfaces, pointing devices, keyboards, audio input devices, voice or speech-based input and control devices, video input devices, haptic input devices, devices for receiving wired or wireless data transmissions, and the like) or any combination of such devices.

Similarly, various interactions with the simplified computing device 10 and with any other component or feature of the task information exposition technique implementations described herein, including input, output, control, feedback, and response to one or more users or other devices or systems associated with the task information exposition technique implementations, are enabled by a variety of Natural User Interface (NUI) scenarios. The NUI techniques and scenarios enabled by the task information exposition technique implementations include, but are not limited to, interface technologies that allow one or more users user to interact with the task information exposition technique implementations in a “natural” manner, free from artificial constraints imposed by input devices such as mice, keyboards, remote controls, and the like.

Such NUI implementations are enabled by the use of various techniques including, but not limited to, using NUI information derived from user speech or vocalizations captured via microphones or other sensors (e.g., speech and/or voice recognition). Such NUI implementations are also enabled by the use of various techniques including, but not limited to, information derived from a user's facial expressions and from the positions, motions, or orientations of a user's hands, fingers, wrists, arms, legs, body, head, eyes, and the like, where such information may be captured using various types of 2D or depth imaging devices such as stereoscopic or time-of-flight camera systems, infrared camera systems, RGB (red, green and blue) camera systems, and the like, or any combination of such devices. Further examples of such NUI implementations include, but are not limited to, NUI information derived from touch and stylus recognition, gesture recognition (both onscreen and adjacent to the screen or display surface), air or contact-based gestures, user touch (on various surfaces, objects or other users), hover-based inputs or actions, and the like. Such NUI implementations may also include, but are not limited, the use of various predictive machine intelligence processes that evaluate current or past user behaviors, inputs, actions, etc., either alone or in combination with other NUI information, to predict information such as user intentions, desires, and/or goals. Regardless of the type or source of the NUI-based information, such information may then be used to initiate, terminate, or otherwise control or interact with one or more inputs, outputs, actions, or functional features of the task information exposition technique implementations described herein.

However, it should be understood that the aforementioned exemplary NUI scenarios may be further augmented by combining the use of artificial constraints or additional signals with any combination of NUI inputs. Such artificial constraints or additional signals may be imposed or generated by input devices such as mice, keyboards, and remote controls, or by a variety of remote or user worn devices such as accelerometers, electromyography (EMG) sensors for receiving myoelectric signals representative of electrical signals generated by user's muscles, heart-rate monitors, galvanic skin conduction sensors for measuring user perspiration, wearable or remote biosensors for measuring or otherwise sensing user brain activity or electric fields, wearable or remote biosensors for measuring user body temperature changes or differentials, and the like. Any such information derived from these types of artificial constraints or additional signals may be combined with any one or more NUI inputs to initiate, terminate, or otherwise control or interact with one or more inputs, outputs, actions, or functional features of the task information exposition technique implementations described herein.

The simplified computing device 10 may also include other optional components such as one or more conventional computer output devices 22 (e.g., display device(s) 24, audio output devices, video output devices, devices for transmitting wired or wireless data transmissions, and the like). Note that typical communications interfaces 18, input devices 20, output devices 22, and storage devices 26 for general-purpose computers are well known to those skilled in the art, and will not be described in detail herein.

The simplified computing device 10 shown in FIG. 13 may also include a variety of computer-readable media. Computer-readable media can be any available media that can be accessed by the computer 10 via storage devices 26, and can include both volatile and nonvolatile media that is either removable 28 and/or non-removable 30, for storage of information such as computer-readable or computer-executable instructions, data structures, programs, sub-programs, or other data. Computer-readable media includes computer storage media and communication media. Computer storage media refers to tangible computer-readable or machine-readable media or storage devices such as digital versatile disks (DVDs), blu-ray discs (BD), compact discs (CDs), floppy disks, tape drives, hard drives, optical drives, solid state memory devices, random access memory (RAM), read-only memory (ROM), electrically erasable programmable read-only memory (EEPROM), CD-ROM or other optical disk storage, smart cards, flash memory (e.g., card, stick, and key drive), magnetic cassettes, magnetic tapes, magnetic disk storage, magnetic strips, or other magnetic storage devices. Further, a propagated signal is not included within the scope of computer-readable storage media.

Retention of information such as computer-readable or computer-executable instructions, data structures, programs, sub-programs, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. Note that the terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, sub-programs, and/or computer program products embodying some or all of the various task information exposition technique implementations described herein, or portions thereof, may be stored, received, transmitted, or read from any desired combination of computer-readable or machine-readable media or storage devices and communication media in the form of computer-executable instructions or other data structures. Additionally, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

The task information exposition technique implementations described herein may be further described in the general context of computer-executable instructions, such as programs, sub-programs, being executed by a computing device. Generally, sub-programs include routines, programs, objects, components, data structures, and the like, that perform particular tasks or implement particular abstract data types. The task information exposition technique implementations may also be practiced in distributed computing environments where tasks are performed by one or more remote processing devices, or within a cloud of one or more devices, that are linked through one or more communications networks. In a distributed computing environment, sub-programs may be located in both local and remote computer storage media including media storage devices. Additionally, the aforementioned instructions may be implemented, in part or in whole, as hardware logic circuits, which may or may not include a processor.

Alternatively, or in addition, the functionality described herein can be performed, at least in part, by one or more hardware logic components. For example, and without limitation, illustrative types of hardware logic components that can be used include FPGAs, application-specific integrated circuits (ASICs), application-specific standard products (ASSPs), system-on-a-chip systems (SOCs), complex programmable logic devices (CPLDs), and so on.

### 5.0 Claim Support and Further Implementations

The following paragraphs summarize various examples of implementations which may be claimed in the present document. However, it should be understood that the implementations summarized below are not intended to limit the subject matter which may be claimed in view of the foregoing descriptions. Further, any or all of the implementations summarized below may be claimed in any desired combination with some or all of the implementations described throughout the foregoing description and any implementations illustrated in one or more of the figures, and any other implementations described below. In addition, it should be noted that the following implementations are intended to be understood in view of the foregoing description and figures described throughout this document.

In one implementation a first system is employed for exposing task information. This first system includes a first task information exposer that includes one or more computing devices, the computing devices being in communication with each other via a computer network whenever there is a plurality of computing devices. The first system also includes a computer program having a plurality of sub-programs executable by the computing devices, where the sub-programs configure the computing devices to, receive a dataset that includes one or more electronic messages, identify one or more task intents in the dataset, each of the identified task intents including a specific task that is to be completed, and for each of the identified task intents, identify one or more service providers each of whom offers one or more online services that are capable of assisting in the fulfillment of the identified task intent, and expose information associated with the identified task intent to each of the identified service providers.

In one implementation of the just-described first system the one or more electronic messages include one or more email messages. In one version of this implementation the one or more email messages includes one or more email threads. In another implementation the one or more electronic messages include one or more of: one or more instant text messages; or one or more instant multimedia messages; or one or more online chat messages; or one or more fax messages having been converted to text using an optical character recognition method; or one or more recorded voice messages having been converted to text using a speech-to-text conversion method; or one or more recorded video messages that include audio having been converted to text using a speech-to-text conversion method; or one or more web-based blog postings; or one or more user postings on one or more social networking websites.

In another implementation the first system further includes a service provider registry that includes a prescribed list of task intents, each of the task intents in this list being mapped to one or more registered service providers each of whom offers one or more online services that are capable of assisting in the fulfillment of the task intent in the list, and the sub-program for identifying one or more service providers each of whom offers one or more online services that are capable of assisting in the fulfillment of the identified task intent includes a sub-program for, whenever the identified task intent exists in the list, assigning the one or more registered service providers that are mapped to the identified task intent to be the identified service providers.

In one version of the just-described implementation, for each of the registered service providers that is mapped to each of the task intents in the list, the service provider registry specifies any specific types of information related to the task intent that the registered service provider requested be provided to the service provider in order for the service provider to be able to assist in the fulfillment of the task intent in the list, and the sub-program for exposing information associated with the identified task intent to each of the identified service providers includes sub-programs for: identifying a person who is mentioned in the dataset and is assigned to fulfill the identified task intent; and for each of the registered service providers that is mapped to the identified task intent, whenever one or more of the specific types of information that the registered service provider requested be provided thereto are unknown, querying the identified person for this unknown information, receiving the unknown information from the identified person, and sending this received information to the registered service provider. In one variant of the just-described version the sub-program for exposing information associated with the identified task intent to each of the identified service providers further includes a sub-program for storing the received information for future use. In another variant of the just-described version the sub-program for querying the identified person for the unknown information includes a sub-program for asking the identified person to consent to exposing the unknown information to the registered service provider.

In another implementation the sub-program for exposing information associated with the identified task intent to each of the identified service providers includes sub-programs for: extracting data specifically related to the identified task intent from the dataset; and sending this extracted data to each of the identified service providers. In one version of this implementation the sub-program for exposing information associated with the identified task intent to each of the identified service providers further includes a sub-program for storing the extracted data for future use.

In another implementation the sub-program for exposing information associated with the identified task intent to each of the identified service providers includes sub-programs for: identifying a person who is mentioned in the dataset and is assigned to fulfill the identified task intent; receiving another dataset that includes personal information that is learned about the identified person; selecting one or more items of this personal information that are specifically related to the identified task intent; and sending the selected items of the personal information to each of the identified service providers. In one version of the just-described implementation the personal information that is learned about the identified person includes one or more of: the geographic location where the identified person lives; or the geographic location where the identified person works; or one or more commute characteristics for the identified person; or personal preferences of the identified person; or information about the identified person that is subject to change over time; or personal contacts of the identified person; or professional contacts of the identified person; or a prescribed identifier for the identified person. In one variant of this version the information about the identified person that is subject to change over time includes one or more of: the current geographic location of the identified person; or the time zone where the identified person is currently located; or the skills of the identified person; or the interests of the identified person; or the experience of the identified person; or information related to an upcoming meeting the identified person is scheduled to attend. In another version of the just-described implementation the sub-program for selecting one or more items of the personal information that are specifically related to the identified task intent includes a sub-program for asking the identified person to consent to exposing these selected items of the personal information to the identified service providers.

The implementations, versions and variants described in any of the previous paragraphs in this section may also be combined with each other, and with one or more of the implementations, versions and variants described prior to this section. For example, some or all of the preceding implementations, versions and variants may be combined with the foregoing implementation where the sub-program for exposing information associated with the identified task intent to each of the identified service providers includes sub-programs for: extracting data specifically related to the identified task intent from the dataset; and sending this extracted data to each of the identified service providers. In addition some or all of the preceding implementations, versions and variants may be combined with the foregoing implementation where the sub-program for exposing information associated with the identified task intent to each of the identified service providers includes sub-programs for: identifying a person who is mentioned in the dataset and is assigned to fulfill the identified task intent; receiving another dataset that includes personal information that is learned about the identified person; selecting one or more items of this personal information that are specifically related to the identified task intent; and sending the selected items of the personal information to each of the identified service providers.

In another implementation a second system is employed for exposing task information. This second system includes a second task information exposer that includes one or more computing devices, the computing devices being in communication with each other via a computer network whenever there is a plurality of computing devices. The second system also includes a computer program having a plurality of sub-programs executable by the computing devices, where the sub-programs configure the computing devices to, receive a dataset that includes one or more electronic messages, identify one or more task intents in the dataset, each of the identified task intents including a specific task that is to be completed, and for each of the identified task intents, identify a person who is mentioned in the dataset and is assigned to fulfill the identified task intent, identify one or more service providers each of whom offers one or more online services that are capable of assisting in the fulfillment of the identified task intent, send a list of the identified service providers to the identified person, receive a one of the identified service providers in this list that is selected by the identified person, and expose information associated with the identified task intent to the selected one of the identified service providers.

In one implementation of the just-described second system, whenever the identified service providers include a plurality of service providers, the sub-program for sending a list of the identified service providers to the identified person includes sub-programs for: ranking the identified service providers using one or more prescribed provider ranking factors, this ranking resulting in a rank-ordered list of identified service providers; and sending the rank-ordered list of identified service providers to the identified person. In another implementation, whenever the identified service providers include a plurality of service providers, the sub-program for sending a list of the identified service providers to the identified person includes sub-programs for: ranking the identified service providers using one or more prescribed provider ranking factors; and sending a prescribed number of the identified service providers having the highest ranking to the identified person.

In another implementation where the selected one of the identified service providers requested that one or more specific types of information be provided to this selected provider in order for the selected provider to be able to assist in the fulfillment of the identified task intent, the sub-program for exposing information associated with the identified task intent to the selected one of the identified service providers includes sub-programs for: whenever one or more of these specific types of information are unknown, querying the identified person for this unknown information; receiving the unknown information from the identified person; and sending this received information to the selected one of the identified service providers. In another implementation the sub-programs further configure the computing devices to: receive a services list that includes each of the one or more online services offered by the selected one of the identified service providers that are capable of assisting in the fulfillment of the identified task intent; and send the services list to the identified person.

The implementations, versions and variants described in any of the previous paragraphs in this section may also be combined with each other, and with one or more of the implementations, versions and variants described prior to this section. For example, some or all of the preceding implementations, versions and variants may be combined with the foregoing implementation where the selected one of the identified service providers requested that one or more specific types of information be provided to this selected provider in order for the selected provider to be able to assist in the fulfillment of the identified task intent, and the sub-program for exposing information associated with the identified task intent to the selected one of the identified service providers includes sub-programs for: whenever one or more of these specific types of information are unknown, querying the identified person for this unknown information; receiving the unknown information from the identified person; and sending the received information to the selected one of the identified service providers. In addition some or all of the preceding implementations, versions and variants may be combined with the foregoing implementation where the sub-programs further configure the computing devices to: receive a services list that includes each of the one or more online services offered by the selected one of the identified service providers that are capable of assisting in the fulfillment of the identified task intent; and send the services list to the identified person.

In another implementation a computer-implemented process is employed for exposing task information. This process includes the actions of: using one or more computing devices to perform the following process actions, the computing devices being in communication with each other via a computer network whenever a plurality of computing devices is used: receiving a dataset that includes one or more electronic messages; identifying one or more task intents in the dataset, each of the identified task intents including a specific task that is to be completed; and for each of the identified task intents, identifying one or more service providers each of whom offers one or more online services that are capable of assisting in the fulfillment of the identified task intent, and exposing information associated with the identified task intent to each of the identified service providers.

In another implementation a first task exposition system is implemented by a first means for exposing task information. The first task exposition system includes a first task information exposer that includes one or more computing devices. These computing devices are in communication with each other via a computer network whenever there is a plurality of computing devices. These computing devices include processors that are configured to execute: a first reception step for receiving a dataset that includes one or more electronic messages; a first identification step for identifying one or more task intents in the dataset, each of the identified task intents including a specific task that is to be completed; and for each of the identified task intents, a second identification step for identifying one or more service providers each of whom offers one or more online services that are capable of assisting in the fulfillment of the identified task intent, and an exposition step for exposing information associated with the identified task intent to each of the identified service providers.

In one implementation of the just-described first task exposition system the system further includes a service provider registry that includes a prescribed list of task intents, each of the task intents in this list being mapped to one or more registered service providers each of whom offers one or more online services that are capable of assisting in the fulfillment of the task intent in the list, and the second identification step for identifying one or more service providers each of whom offers one or more online services that are capable of assisting in the fulfillment of the identified task intent includes an assignment step for, whenever the identified task intent exists in the list, assigning the one or more registered service providers that are mapped to the identified task intent to be the identified service providers. In one version of this implementation, for each of the registered service providers that is mapped to each of the task intents in the list, the service provider registry specifies any specific types of information related to the task intent that the registered service provider requested be provided to this service provider in order for this service provider to be able to assist in the fulfillment of the task intent in the list, and the exposition step for exposing information associated with the identified task intent to each of the identified service providers includes: a third identification step for identifying a person who is mentioned in the dataset and is assigned to fulfill the identified task intent; and for each of the registered service providers that is mapped to the identified task intent, whenever one or more of the specific types of information that the registered service provider requested be provided thereto are unknown, a query step for querying the identified person for this unknown information, a second reception step for receiving the unknown information from the identified person, and a first transmission step for sending this received information to the registered service provider.

In another implementation of the first task exposition system the exposition step for exposing information associated with the identified task intent to each of the identified service providers includes: an extraction step for extracting data specifically related to the identified task intent from the dataset; and a second transmission step for sending this extracted data to each of the identified service providers. In another implementation of the first task exposition system the exposition step for exposing information associated with the identified task intent to each of the identified service providers includes: a fourth identification step for identifying a person who is mentioned in the dataset and is assigned to fulfill the identified task intent; a third reception step for receiving another dataset that includes personal information that is learned about the identified person; a selection step for selecting one or more items of this personal information that are specifically related to the identified task intent; and a third transmission step for sending the selected items of the personal information to each of the identified service providers. In one version of the just-described implementation the selection step for selecting one or more items of this personal information that are specifically related to the identified task intent includes a question step for asking the identified person to consent to exposing the selected items of the personal information to the identified service providers.

In another implementation a second task exposition system is implemented by a second means for exposing task information. The second task exposition system includes a second task information exposer that includes one or more computing devices. These computing devices are in communication with each other via a computer network whenever there is a plurality of computing devices. These computing devices include processors that are configured to execute: a first reception step for receiving a dataset that includes one or more electronic messages; a first identification step for identifying one or more task intents in the dataset, each of the identified task intents including a specific task that is to be completed; and for each of the identified task intents, a second identification step for identifying a person who is mentioned in the dataset and is assigned to fulfill the identified task intent, a third identification step for identifying one or more service providers each of whom offers one or more online services that are capable of assisting in the fulfillment of the identified task intent, a first transmission step for sending a list of the identified service providers to the identified person, a second reception step for receiving a one of the identified service providers in this list that is selected by the identified person, and an exposition step for exposing information associated with the identified task intent to the selected one of the identified service providers.

In one implementation of the just-described second task exposition system, whenever the identified service providers include a plurality of service providers, the first transmission step for sending a list of the identified service providers to the identified person includes: a first ranking step for ranking the identified service providers using one or more prescribed provider ranking factors, this ranking resulting in a rank-ordered list of identified service providers; and a second transmission step for sending the rank-ordered list of identified service providers to the identified person. In another implementation of the second task exposition system, whenever the identified service providers include a plurality of service providers, the the first transmission step for sending a list of the identified service providers to the identified person includes: a second ranking step for ranking the identified service providers using one or more prescribed provider ranking factors; and a third transmission step for sending a prescribed number of the identified service providers having the highest ranking to the identified person.

In another implementation of the second task exposition system, the selected one of the identified service providers requested that one or more specific types of information be provided to this selected provider in order for the selected provider to be able to assist in the fulfillment of the identified task intent, and the exposition step for exposing information associated with the identified task intent to the selected one of the identified service providers includes: whenever one or more of the specific types of information are unknown, a query step for querying the identified person for this unknown information; a third reception step for receiving the unknown information from the identified person; and a fourth transmission step for sending this received information to the selected one of the identified service providers. In another implementation of the second task exposition system, the processors are further configured to execute: a fourth reception step for receiving a services list that includes each of the one or more online services offered by the selected one of the identified service providers that are capable of assisting in the fulfillment of the identified task intent; and a fifth transmission step for sending the services list to the identified person.

Wherefore, what is claimed is:

1. A system for exposing task information, comprising:
a task information exposer comprising one or more computing devices, said computing devices being in communication with each other via a computer network whenever there is a plurality of computing devices, and a computer program having a plurality of sub-programs executable by said computing devices, wherein the sub-programs configure said computing devices to,
receive a dataset comprising one or more electronic messages,
identify one or more task intents in the dataset, each of the identified task intents comprising a specific task that is to be completed, and
for each of the identified task intents,
identify one or more service providers each of whom offers one or more online services that are capable of assisting in the fulfillment of the identified task intent, and
expose information associated with the identified task intent to each of the identified service providers.

2. The system of claim 1, wherein the one or more electronic messages comprise one or more email messages.

3. The system of claim 2 wherein the one or more email messages comprise one or more email threads.

4. The system of claim 1, wherein the one or more electronic messages comprise one or more of:
one or more instant text messages; or
one or more instant multimedia messages; or
one or more online chat messages; or
one or more fax messages having been converted to text using an optical character recognition method; or
one or more recorded voice messages having been converted to text using a speech-to-text conversion method; or
one or more recorded video messages comprising audio having been converted to text using a speech-to-text conversion method; or
one or more web-based blog postings; or
one or more user postings on one or more social networking websites.

5. The system of claim 1, wherein the system further comprises a service provider registry comprising a prescribed list of task intents, each of the task intents in said list being mapped to one or more registered service providers each of whom offers one or more online services that are capable of assisting in the fulfillment of the task intent in said list, and the sub-program for identifying one or more service providers each of whom offers one or more online services that are capable of assisting in the fulfillment of the identified task intent comprises a sub-program for, whenever the identified task intent exists in said list, assigning the one or more registered service providers that are mapped to the identified task intent to be the identified service providers.

6. The system of claim 5, wherein for each of the registered service providers that is mapped to each of the task intents in said list, the service provider registry specifies any specific types of information related to the task intent that the registered service provider requested be provided to said service provider in order for said service provider to be able to assist in the fulfillment of the task intent in said list, and the sub-program for exposing information associated with the identified task intent to each of the identified service providers comprises sub-programs for:
identifying a person who is mentioned in the dataset and is assigned to fulfill the identified task intent; and
for each of the registered service providers that is mapped to the identified task intent,
whenever one or more of said specific types of information that the registered service provider requested be provided thereto are unknown, querying the identified person for said unknown information,
receiving said unknown information from the identified person, and
sending said received information to the registered service provider.

7. The system of claim 6, wherein the sub-program for exposing information associated with the identified task intent to each of the identified service providers further comprises a sub-program for storing said received information for future use.

8. The system of claim 6, wherein the sub-program for querying the identified person for said unknown information comprises a sub-program for asking the identified person to consent to exposing said unknown information to the registered service provider.

9. The system of claim 1, wherein the sub-program for exposing information associated with the identified task intent to each of the identified service providers comprises sub-programs for:
extracting data specifically related to the identified task intent from the dataset; and
sending said extracted data to each of the identified service providers.

10. The system of claim 9, wherein the sub-program for exposing information associated with the identified task intent to each of the identified service providers further comprises a sub-program for storing said extracted data for future use.

11. The system of claim 1, wherein the sub-program for exposing information associated with the identified task intent to each of the identified service providers comprises sub-programs for:
identifying a person who is mentioned in the dataset and is assigned to fulfill the identified task intent;
receiving another dataset comprising personal information that is learned about the identified person;
selecting one or more items of said personal information that are specifically related to the identified task intent; and
sending the selected items of said personal information to each of the identified service providers.

12. The system of claim 11, wherein the personal information that is learned about the identified person comprises one or more of:
the geographic location where the identified person lives; or
the geographic location where the identified person works; or
one or more commute characteristics for the identified person; or
personal preferences of the identified person; or
information about the identified person that is subject to change over time; or
personal contacts of the identified person; or
professional contacts of the identified person; or
a prescribed identifier for the identified person.

13. The system of claim 12, wherein the information about the identified person that is subject to change over time comprises one or more of:
the current geographic location of the identified person; or
the time zone where the identified person is currently located; or
the skills of the identified person; or
the interests of the identified person; or
the experience of the identified person; or
information related to an upcoming meeting the identified person is scheduled to attend.

14. The system of claim 11, wherein the sub-program for selecting one or more items of said personal information that are specifically related to the identified task intent comprises a sub-program for asking the identified person to consent to exposing said selected items of said personal information to the identified service providers.

15. A system for exposing task information, comprising:
a task information exposer comprising one or more computing devices, said computing devices being in communication with each other via a computer network whenever there is a plurality of computing devices, and a computer program having a plurality of sub-programs executable by said computing devices, wherein the sub-programs configure said computing devices to,
receive a dataset comprising one or more electronic messages,
identify one or more task intents in the dataset, each of the identified task intents comprising a specific task that is to be completed, and
for each of the identified task intents,
identify a person who is mentioned in the dataset and is assigned to fulfill the identified task intent,
identify one or more service providers each of whom offers one or more online services that are capable of assisting in the fulfillment of the identified task intent,
send a list of the identified service providers to the identified person,
receive a one of the identified service providers in said list that is selected by the identified person, and
expose information associated with the identified task intent to the selected one of the identified service providers.

16. The system of claim 15, wherein, whenever the identified service providers comprise a plurality of service providers, the sub-program for sending a list of the identified service providers to the identified person comprises sub-programs for:
ranking the identified service providers using one or more prescribed provider ranking factors, said ranking resulting in a rank-ordered list of identified service providers; and
sending the rank-ordered list of identified service providers to the identified person.

17. The system of claim 15, wherein, whenever the identified service providers comprise a plurality of service providers, the sub-program for sending a list of the identified service providers to the identified person comprises sub-programs for:
ranking the identified service providers using one or more prescribed provider ranking factors; and
sending a prescribed number of the identified service providers having the highest ranking to the identified person.

18. The system of claim 15, wherein, the selected one of the identified service providers requested that one or more specific types of information be provided to said selected provider in order for said selected provider to be able to assist in the fulfillment of the identified task intent, and the sub-program for exposing information associated with the identified task intent to the selected one of the identified service providers comprises sub-programs for:
whenever one or more of said specific types of information are unknown, querying the identified person for said unknown information;
receiving said unknown information from the identified person; and
sending said received information to the selected one of the identified service providers.

19. The system of claim 15, wherein the sub-programs further configure said computing devices to:
receive a services list comprising each of the one or more online services offered by the selected one of the identified service providers that are capable of assisting in the fulfillment of the identified task intent; and
send the services list to the identified person.

20. A computer-implemented process for exposing task information, the process comprising the actions of:
using one or more computing devices to perform the following process actions, the computing devices being in communication with each other via a computer network whenever a plurality of computing devices is used:
receiving a dataset comprising one or more electronic messages;
identifying one or more task intents in the dataset, each of the identified task intents comprising a specific task that is to be completed; and
for each of the identified task intents,
identifying one or more service providers each of whom offers one or more online services that are capable of assisting in the fulfillment of the identified task intent, and
exposing information associated with the identified task intent to each of the identified service providers.
